(19) United States
(12) Patent Application Publication
(10) Pub. No.: US 2025/0111814 A1
(43) Pub. Date: Apr. 3, 2025

(54) DISPLAY DEVICE AND SOURCE DRIVER

(71) Applicant: LAPIS Technology Co., Ltd., Yokohama (JP)

(72) Inventor: Koji HIGUCHI, Yokohama (JP)

(73) Assignee: LAPIS Technology Co., Ltd., Yokohama (JP)

(21) Appl. No.: 18/896,837

(22) Filed: Sep. 25, 2024

(30) Foreign Application Priority Data
Sep. 29, 2023 (JP) 2023-169875

(51) Int. Cl. G09G 3/20; G06T 7/90

(52) U.S. Cl. CPC G09G 3/2007; G06T 7/90; G06T 2207/10016; G09G 2310/027; G09G 2320/0233; G09G 2320/0276

(57) ABSTRACT

A display device includes a video data signal output portion including a gamma setting data generation portion that generates gamma setting data, which is setting information for gamma correction corresponding to at least one partial area of a display screen of the display panel, based on the video data. The source driver includes: a gamma curve generation portion, configured to receive the gamma setting data and generate a local gamma correction curve, which is a gamma correction curve corresponding to the at least one partial area, based on the gamma setting data; a decoder portion, configured to perform gamma correction of gradation voltages corresponding to the plurality of pixel data fragments for each of the at least one partial area based on the local gamma correction curve; and an output portion, configured to output the pixel driving voltage based on the gradation voltages that have undergone the gamma correction.

### CROSS-REFERENCE TO RELATED APPLICATIONS

This application claims the priority benefit of Japan Application No. 2023-169875, filed on Sep. 29, 2023. The entirety of the above-described Patent Application is hereby incorporated by reference herein and made a part of the present specification.

### BACKGROUND

### Technical Field

The disclosure relates to a display device and a source driver.

### Description of Related Art

In display devices including display elements such as liquid crystal or organic EL (OLED), brightness correction (gamma correction) using gamma curves is performed. As a circuit for performing such gamma correction, a gamma correction circuit has been proposed (for example, in Japanese Patent Application Laid-Open (JP-A) No. 2009-25665) that performs gamma correction matching a desired gamma correction curve by selecting gradation voltages corresponding to specific scenarios using a gradation voltage generator, and finely adjusting the selected gradation voltages by changing first and second reference standard voltages set in setting registers.

### SUMMARY

In recent years, in applications such as display systems for video conferencing, multiple images from different sources are being displayed within a single display. When images with different average brightness levels exist among these multiple images, image quality adjustment is performed to allocate more gradations around the respective average brightness levels. For example, in the case where both images with crushed blacks and blown-out whites exist among the multiple images, more gradations are allocated to both the black areas and the white areas.

However, when such gradation allocation is performed, there was a problem that the number of gradations near the middle gradations between the black areas and white areas becomes reduced, resulting in coarse gradations and causing the so-called loss of gradation.

The disclosure provides a display device capable of performing image quality adjustment without causing loss of gradation when images with different gradations are displayed in partial areas within the display screen.

The display device according to the disclosure includes: a display panel having a plurality of source lines and a plurality of gate lines, and a plurality of pixel portions arranged in a matrix at each intersection portion of the plurality of source lines and the plurality of gate lines; a video data signal output portion, configured to receive input of video data and output a video data signal including a series of a plurality of pixel data fragments based on the video data; and a source driver, configured to receive the video data signal supplied from the video data signal output portion and output a pixel driving voltage to be applied to the plurality of pixel portions based on the video data signal. The video data signal output portion includes a gamma setting data generation portion that generates, for at least one partial area of a display screen of the display panel, gamma setting data, which is setting information for gamma correction corresponding to the at least one partial area, based on the video data. The source driver includes: a gamma curve generation portion, configured to receive the gamma setting data and generate a local gamma correction curve, which is a gamma correction curve corresponding to the at least one partial area, based on the gamma setting data; a decoder portion, configured to perform gamma correction of gradation voltages corresponding to the plurality of pixel data fragments for each of the at least one partial area based on the local gamma correction curve; and an output portion, configured to output the pixel driving voltage based on the gradation voltages that have undergone the gamma correction.

The source driver according to the disclosure is a source driver configured to be connected to a display panel having a plurality of source lines and a plurality of pixel portions connected to the plurality of source lines, receive a video data signal including a series of plurality of pixel data fragments, and output a pixel driving voltage to be applied to the plurality of pixel portions based on the video data signal, which includes: a gamma curve generation portion, configured to receive input of gamma setting data, which is setting information for gamma correction corresponding to at least one partial area of a display screen of the display panel, and generate a local gamma correction curve, which is a gamma correction curve corresponding to the at least one partial area, based on the gamma setting data; a decoder portion, configured to perform gamma correction of gradation voltages corresponding to the plurality of pixel data fragments for each of the at least one partial area based on the local gamma correction curve; and an output portion, configured to output the pixel driving voltage based on the gradation voltages that have undergone the gamma correction.

### BRIEF DESCRIPTION OF THE DRAWINGS

FIG. 1 is a block diagram showing the configuration of the display device according to the embodiment of the disclosure.

FIG. 2 is a diagram showing an example of the display screen where different images are displayed in multiple windows.

FIG. 3 is a block diagram showing the configuration of the timing controller and the source driver.

FIG. 4 is a block diagram showing the configuration of the image data latch circuit, the decoder circuit, and the decoder selection circuit.

FIG. 5A is a diagram showing an example of a gamma curve for the entire display image in FIG. 2.

FIG. 5B is a diagram showing an example of a gamma correction curve corresponding to the first window in FIG. 2.

FIG. 5C is a diagram showing an example of a gamma correction curve corresponding to the second window in FIG. 2.

### DESCRIPTION OF THE EMBODIMENTS

According to the display device of the disclosure, in the case where images with different gradations are displayed in partial areas within the display screen, it is possible to perform image quality adjustment without causing loss of gradation.

A preferred embodiment of the disclosure will be described in detail below. In addition, in the following description of the embodiment and the accompanying drawings, substantially the same or equivalent parts are given the same reference numerals.

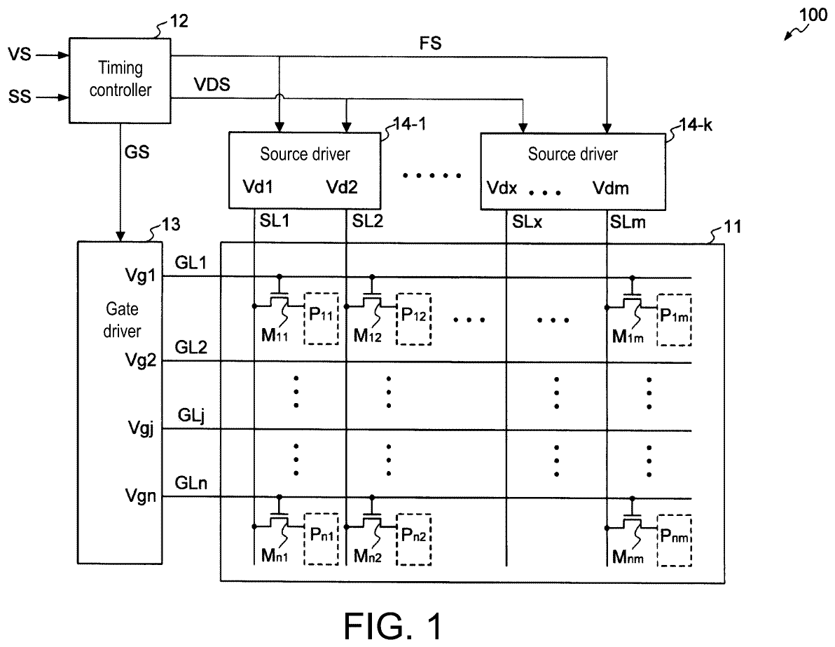

FIG. 1 is a block diagram showing the configuration of the display device according to the embodiment of the disclosure. The display device 100 is an active matrix-driven liquid crystal display device. The display device 100 includes a display panel 11, a timing controller 12, a gate driver 13, and source drivers 14-1 to 14-k.

The display panel 11 is composed of a semiconductor substrate on which multiple pixel portions P11 to Pnm and pixel switches M11 to Mnm (n, m: natural numbers of 2 or greater) are arranged in a matrix. The display panel 11 includes n gate lines GL1 to GLn, each extending in the horizontal direction as scanning lines, and m source lines SL1 to SLm arranged to intersect with the gate lines as data lines. The pixel portions P11 to Pnm and pixel switches M11 to Mnm are provided at the intersection portions of the gate lines GL1 to GLn and the source lines SL1 to SLm.

The pixel switches M11 to Mnm are controlled to be on or off in response to the gate signals Vg1 to Vgn supplied from the gate driver 13.

The pixel portions P11 to Pnm receive the gradation voltages (driving voltages) corresponding to video data supplied from the source drivers 14-1 to 14-k. Specifically, pixel driving voltage signals Vd1 to Vdm are output from the source drivers 14-1 to 14-k to the source lines SL1 to SLm, and the pixel driving voltage signals Vd1 to Vdm are applied to the pixel portions P11 to Pnm when the respective pixel switches M11 to Mnm are on. As a result, each pixel electrode of the pixel portions P11 to Pnm is charged, and the brightness is controlled.

Each of the pixel portions P11 to Pnm includes a transparent electrode connected to the source lines SL1 to SLm through the pixel switches M11 to Mnm, and liquid crystal sealed between the transparent electrode and an opposing substrate formed opposite to the semiconductor substrate and having a single transparent electrode formed over the entire surface. With respect to the backlight inside the display device, display is performed by changing the transmittance of the liquid crystal according to the potential difference between the gradation voltage (driving voltage) applied to the pixel portions P11 to Pnm and the opposing substrate voltage.

The timing controller 12 generates a series (serial signal) of pixel data fragments PD representing the brightness level of each pixel in, for example, 256 levels of brightness gradation with 8 bits, based on the video data VS. Further, the timing controller 12 generates a clock signal CLK with a constant clock cycle using an embedded clock method based on a synchronization signal SS. The timing controller 12 generates a video data signal VDS, which is a serial signal integrating the series of pixel data fragments PD and the clock signal CLK, and supplies the same to the source drivers 14-1 to 14-k to perform display control of the video data. The video data signal VDS is configured as a serialized video data signal according to the number of transmission paths for every predetermined number of source lines.

In this embodiment, the video data signal VDS for one frame is composed of n groups of pixel data fragments, each consisting of m pixel data fragments PD, arranged serially and continuously. Each of the n groups of pixel data fragments is a group of pixel data fragments composed of pixel data fragments corresponding to gradation voltages to be supplied to the pixels on one horizontal scanning line (i.e., each of the gate lines GL1 to GLn). Through the operation of the source drivers 14-1 to 14-k, based on the m×n pixel data fragments PD, pixel driving voltage signals Vd1 to Vdm to be supplied to n×m pixel portions (i.e., pixel portions P11 to Pnm) are applied via the source lines.

Further, based on the synchronization signal SS, the timing controller 12 generates a frame synchronization signal FS indicating the timing for each frame of the video data signal VDS, and supplies the same to the source driver 14. The timing controller 12 generates a gate control signal GS to control the operation of the gate driver 13, and supplies the same to the gate driver 13.

The gate driver 13 operates in response to receiving the gate control signal GS supplied from the timing controller 12, and based on the clock timing included in the gate control signal GS, sequentially supplies gate signals Vg1 to Vgn to the gate lines GL1 to GLn. By supplying the gate signals Vg1 to Vgn, the pixel portions P11 to Pnm are selected row by row. Then, for the selected pixel portions, gradation voltages are written to the pixel electrodes by applying the pixel driving voltage signals Vd1 to Vdm from the source drivers 14-1 to 14-k.

In other words, through the operation of the gate driver 13, m pixel portions arranged along the extension direction of the gate line (i.e., in a horizontal row) are selected as the supply targets for the pixel driving voltage signals Vd1 to Vdm. The source drivers 14-1 to 14-k apply the pixel driving voltage signals Vd1 to Vdm to the selected horizontal row of pixel portions, causing the same to display colors corresponding to the voltages. By selectively switching the horizontal row of pixel portions selected as the supply targets for the pixel driving voltage signals Vd1 to Vdm, and repeating this process along the extension direction of the source lines (i.e., in the vertical direction), one frame of screen display is performed.

The source drivers 14-1 to 14-k are provided for every predetermined number of data lines divided from the source lines SL1 to SLm. The source drivers 14-1 to 14-k are formed on separate semiconductor IC (Integrated Circuit) chips. For example, in the case where each source driver has 960 outputs and the display panel has one data line per pixel row, a 4K panel is driven by 12 source drivers, while an 8K panel is driven by 24 source drivers for the source lines. The source drivers 14-1 to 14-k receive from the timing controller 12, through separate transmission paths, the frame synchronization signal FS and a serial signal that integrates the clock signal CLK and the video data signal VDS. When there is one pair (two lines) of transmission paths between the timing controller 12 and each data driver, in one data period, the video data VD corresponding to the number of outputs from the source driver is supplied as serialized differential signals.

In this embodiment, multiple windows are displayed on the screen displayed on the display panel 11 (hereinafter referred to as the display screen DS), and multiple images with different sources are displayed in these multiple windows. In the following description, the areas where these windows are displayed are referred to as partial areas of the display screen DS. For example, such display is performed in cases where a TV conference is conducted using a computer connected to the display device 100, or when simultaneously displaying a navigation screen and a back camera image using an in-vehicle navigation device connected to the display device 100.

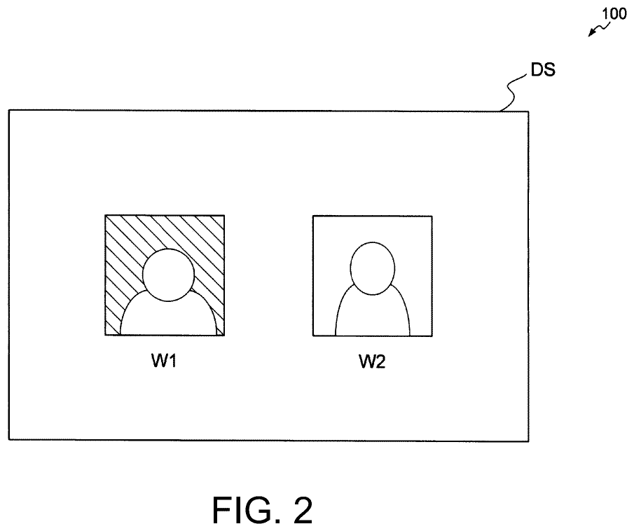

FIG. 2 is a diagram showing an example of the display screen DS where different images are displayed in multiple partial areas (multiple windows). In this example, images of different individuals are displayed in the first window W1 and the second window W2, respectively.

In the first window W1, an image with a dark background and strong overall black gradation is displayed. On the other hand, in the second window W2, an image with a bright background and strong overall white gradation is displayed.

The display device 100 of this embodiment has a function to perform image quality adjustment corresponding to cases where images with different gradations are displayed within such a display screen. This function is described below.

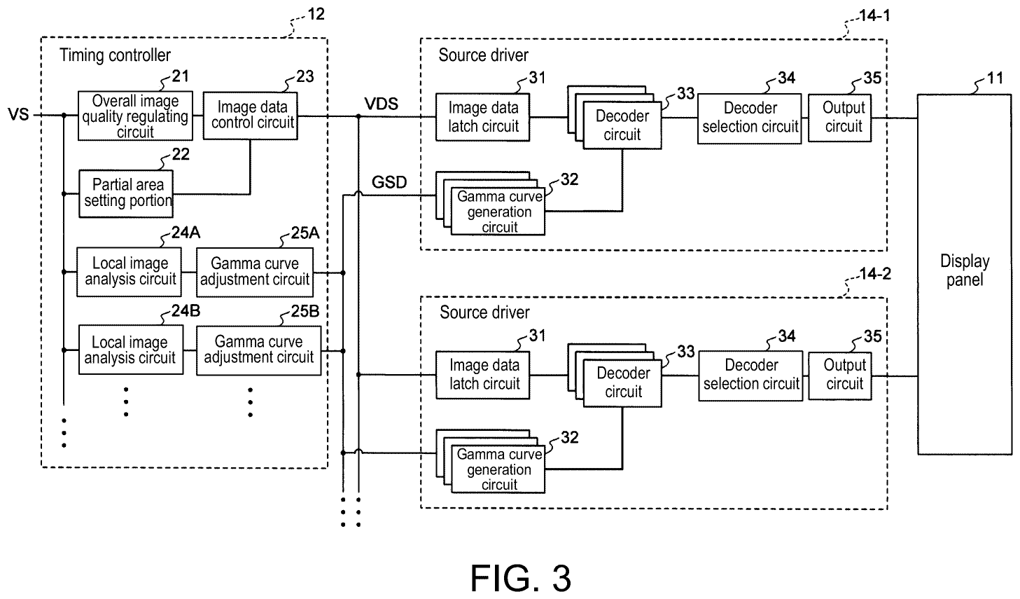

FIG. 3 is a block diagram showing the configuration of the parts related to the image quality adjustment function of the timing controller 12 and the source drivers 14-1 to 14-k. Here, only the source drivers 14-1 and 14-2 are extracted from the source drivers 14-1 to 14-k for illustration.

The timing controller 12 includes an overall image quality regulating circuit 21, a partial area setting portion 22, and an image data control circuit 23. The overall image quality regulating circuit 21 performs overall image quality adjustment of the video data VS.

The partial area setting portion 22 sets a partial area, which is a part of the area within the display screen DS of the display panel 11 where an image is displayed, based on the video data VS. For example, the partial area setting portion 22 sets the partial area based on the display position information and gradation information of the image data included in the video data VS when displayed on the display screen DS. For instance, in the example of FIG. 2, the areas where the first window W1 and the second window W2 are displayed within the display screen DS are set as partial areas, respectively.

The image data control circuit 23 supplies the video data signal VDS, generated based on the video data VS, to the source drivers 14-1 and 14-2 along with the information of the partial areas set by the partial area setting portion 22.

Further, the timing controller 12 includes multiple local image analysis circuits and gamma curve adjustment circuits. FIG. 3 shows only the local image analysis circuits 24A and 24B and the gamma curve adjustment circuits 25A and 25B from among these.

The local image analysis circuit 24A performs gradation analysis on the local image, which is the image displayed in one or multiple partial areas set by the partial area setting portion 22. The gamma curve adjustment circuit 25A generates gamma setting data GSD, which is the setting information for the gamma correction curve corresponding to the partial area, based on the analysis result of the local image analysis circuit 24A. The gamma curve adjustment circuit 25A supplies the generated gamma setting data GSD to the source drivers 14-1 and 14-2.

Similarly, the local image analysis circuit 24B performs gradation analysis on the local image displayed in a partial area different from the local image analyzed by the local image analysis circuit 24A. The gamma curve adjustment circuit 25B generates gamma setting data GSD based on the analysis result of the local image analysis circuit 24B and supplies the same to the source drivers 14-1 and 14-2.

The source driver 14-1 includes an image data latch circuit 31, a gamma curve generation circuit 32, a decoder circuit 33, a decoder selection circuit 34, and an output circuit 35. Multiple gamma curve generation circuits 32 and decoder circuits 33 are provided, respectively.

The image data latch circuit 31 sequentially imports the series of pixel data fragments PD included in the video data signal VDS supplied from the timing controller 12. The image data latch circuit 31 supplies the imported pixel data fragments PD to the decoder circuit 33 each time the image data latch circuit 31 imports a number (m) of pixel data fragments PD corresponding to the gradation voltage signal to be supplied by the source driver 14-1 out of the pixel data fragments PD for one horizontal scanning line.

The gamma curve generation circuit 32 generates a local gamma correction curve, which is a gamma correction curve corresponding to the partial area, based on the gamma setting data GSD supplied from the timing controller 12. In the case of multiple partial areas, multiple local gamma correction curves are generated by multiple gamma curve generation circuits.

Multiple decoder circuits 33 are provided corresponding to multiple gamma curve generation circuits 32, respectively. The decoder selection circuit 34 selects one of the multiple decoder circuits 33 based on the pixel data fragment PD output from the image data latch circuit 31 and the information of the partial area supplied from the timing controller 12.

The decoder circuit 33 receives the pixel data fragment PD supplied from the image data latch circuit 31 and the local gamma correction curve supplied from the gamma curve generation circuit 32. The decoder circuit 33 performs DA conversion of the pixel data fragment PD while performing gamma correction corresponding to the partial area using the local gamma correction curve. That is, the decoder circuit 33 selects, from among the gradation voltages supplied from a gradation voltage generation portion (not shown), a gradation voltage corresponding to the brightness indicated by the pixel data fragment PD it received. The decoder circuit 33 performs gamma correction of the gradation voltage based on the local gamma correction curve supplied from the gamma curve generation circuit 32.

The output circuit 35 amplifies the gradation voltage signal reflecting the gamma correction performed by the decoder circuit 33 and outputs the same as the pixel driving voltage signal Vd.

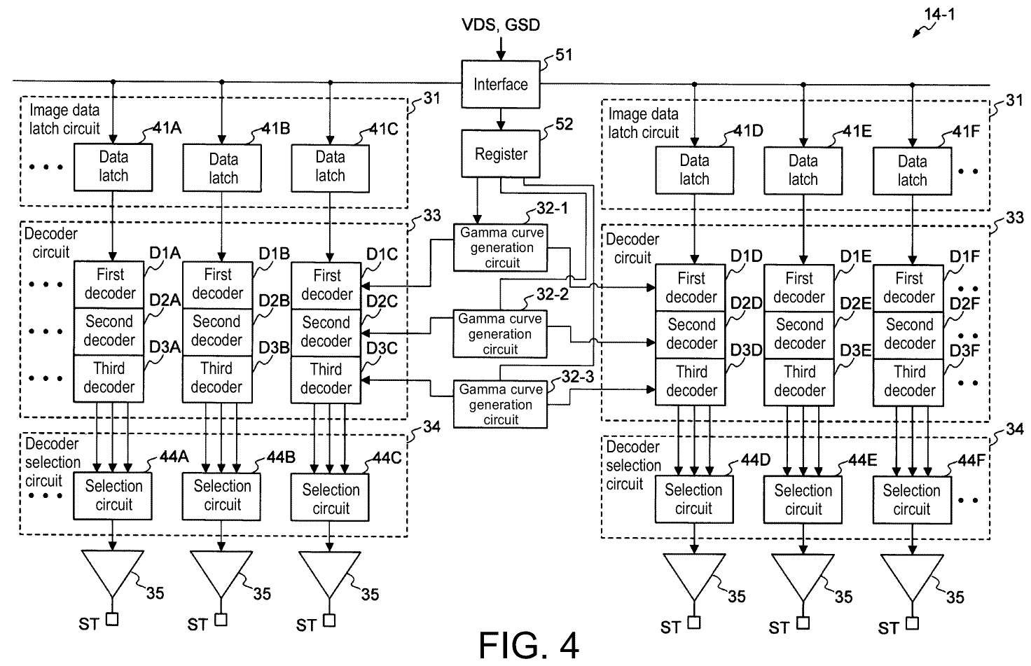

FIG. 4 is a block diagram showing the configuration of the image data latch circuit 31, the decoder circuit 33, and the decoder selection circuit 34.

The video data signal VDS supplied from the timing controller 12 is input to the source driver 14-1 through the interface 51, and is supplied to each of the data latches in the image data latch circuit 31.

Further, the gamma setting data GSD is supplied from the timing controller 12 and stored in the register 52 through the interface 51, and is supplied to the gamma curve generation circuits 32-1 to 32-3.

The image data latch circuit 31 includes data latches 41A to 41F. The data latches 41A to 41F are provided for each channel and sequentially import the series of pixel data fragments PD included in the video data signal VDS through the interface 51.

The decoder circuit 33 includes first decoders D1A to D1F, second decoders D2A to D2F, and third decoders D3A to D3F. That is, in the decoder circuit 33, three decoders are provided for each channel.

The gamma curve generation circuits 32-1 to 32-3 are provided corresponding to the first to third decoders. The gamma curve generation circuit 32 generates a gamma correction curve based on the gamma setting data GSD read from the register 52. The gamma curve generation circuit 32-1 supplies the gamma correction curve to the first decoders D1A to D1F, the gamma curve generation circuit 32-2 supplies the gamma correction curve to the second decoders D2A to D2F, and the gamma curve generation circuit 32-3 supplies the gamma correction curve to the third decoders D3A to D3F, respectively.

The decoder selection circuit 34 includes selection circuits 44A to 44F. The selection circuits 44A to 44F are provided for each channel and select a decoder for each channel.

The output circuit 35 is provided for each channel and outputs the pixel driving voltage signal Vd for each channel from the output terminal ST based on the gradation voltage signal that has undergone gamma correction performed in the decoder selected by the decoder selection circuit 34.

It should be noted that although only channels A to F are shown here, in reality there are many more channels, and each channel has a similar configuration.

As described above, in the display device 100 of this embodiment, partial areas are set, local gamma correction curves are generated for each partial area, and the pixel driving voltage signal Vd is generated by performing gamma correction of gradation voltages based on the generated gamma correction curves.

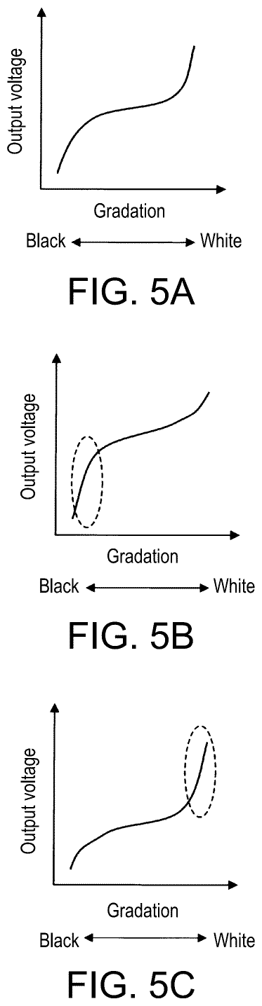

FIG. 5A is a diagram showing a gamma correction curve for the entire display screen DS, which is different from the local gamma correction curve described above. This gamma correction curve is determined by the characteristics of the display panel 11, and in this case, it has a shape that is not biased towards either the black side or the white side.

FIG. 5B shows a local gamma correction curve corresponding to the partial area where the first window W1 is located on the display screen DS shown in FIG. 2. Since the local image displayed in the first window W1 is a dark image, the local gamma correction curve thereof has a steep portion enclosed by a dashed line in the black-side gradation. By performing gamma correction using this local gamma correction curve, the image in the first window W1 is displayed with emphasized black-side gradation.

FIG. 5C shows a local gamma correction curve corresponding to the partial area where the second window W2 is located on the display screen DS shown in FIG. 2. Since the local image displayed in the second window W2 is bright and has a whitish appearance, the local gamma correction curve thereof has a steep portion enclosed by a dashed line in the white-side gradation. By performing gamma correction using this local gamma correction curve, the image in the second window W2 is displayed with emphasized white-side gradation.

In this manner, in the display device 100 of this embodiment, local gamma correction curves are generated for each partial area image, and gamma correction is performed according to the gradation of the local image displayed in the partial area. As a result, for a display screen that includes images with significantly different gradations, the problem that occurs when gamma correction is performed using only one gamma correction curve corresponding to the entire display screen, namely, the so-called loss of gradation problem where the gradation near the intermediate gradation becomes coarse, does not occur.

Thus, according to the display device 100 of this embodiment, in the case where images with different gradations are displayed in partial areas within the display screen, it becomes possible to perform image quality adjustment without causing loss of gradation.

It should be noted that the disclosure is not limited to the embodiment described above. For example, in FIG. 2, a case is described as an example where the first window W1 and the second window W2 are displayed in multiple partial areas of the display screen DS, and images with different gradations are displayed in each window. However, the number of divided areas within the display screen is not limited thereto, and the display device 100 of this embodiment may be applied in the case where at least one partial area exists. At that time, it is only necessary that the gamma correction curve corresponding to the at least one partial area is generated and gamma correction is performed for each partial area.

Further, FIG. 4 describes an example where three decoders, the first to the third, are provided for each channel, but the number of decoders is not limited thereto.

Further, in the above-mentioned embodiment, a case is described where the timing controller 12 includes the overall image quality regulating circuit 21, the partial area setting portion 22, the image data control circuit 23, the local image analysis circuits 24A and 24B, and the gamma curve adjustment circuits 25A and 25B. However, these functions may be provided in a video data signal output portion other than the timing controller 12, for example, they may be provided in a SoC (System on Chip).

Further, in the above-mentioned embodiment, a case where the display device 100 is an active matrix liquid crystal display device is described as an example. However, the display device 100 may be an organic EL (OLED) display device.

What is claimed is:

1. A display device, comprising:
a display panel having a plurality of source lines and a plurality of gate lines, and a plurality of pixel portions arranged in a matrix at each intersection portion of the plurality of source lines and the plurality of gate lines;
a video data signal output portion, configured to receive input of video data and output a video data signal including a series of a plurality of pixel data fragments based on the video data; and
a source driver, configured to receive the video data signal supplied from the video data signal output portion and output a pixel driving voltage to be applied to the plurality of pixel portions based on the video data signal,
wherein the video data signal output portion comprises a gamma setting data generation portion that generates, for at least one partial area of a display screen of the display panel, gamma setting data, which is setting information for gamma correction corresponding to the at least one partial area, based on the video data, and
the source driver comprises:
a gamma curve generation portion, configured to receive the gamma setting data and generate a local gamma correction curve, which is a gamma correction curve corresponding to the at least one partial area, based on the gamma setting data;
a decoder portion, configured to perform gamma correction of gradation voltages corresponding to the plurality of pixel data fragments for each of the at least one partial area based on the local gamma correction curve; and
an output portion, configured to output the pixel driving voltage based on the gradation voltages that have undergone the gamma correction.

2. The display device according to claim 1, wherein
the video data signal output portion comprises a local image analysis portion configured to analyze a gradation of a local image, which is an image displayed in the at least one partial area, based on the video data, and
the gamma setting data generation portion generates the gamma setting data based on an analysis result by the local image analysis portion.

3. The display device according to claim 1, wherein
a plurality of gamma curve generation portions and a plurality of decoder portions are provided for each channel composed of the plurality of source lines, and
the source driver comprises a decoder selection circuit configured to select one of the decoder portions for each channel from among the plurality of decoder portions.

4. A source driver, which is a source driver configured to be connected to a display panel having a plurality of source lines and a plurality of pixel portions connected to the plurality of source lines, receive a video data signal including a series of plurality of pixel data fragments, and output a pixel driving voltage to be applied to the plurality of pixel portions based on the video data signal, the source driver comprising:
a gamma curve generation portion, configured to receive input of gamma setting data, which is setting information for gamma correction corresponding to at least one partial area of a display screen of the display panel, and generate a local gamma correction curve, which is a gamma correction curve corresponding to the at least one partial area, based on the gamma setting data;
a decoder portion, configured to perform gamma correction of gradation voltages corresponding to the plurality of pixel data fragments for each of the at least one partial area based on the local gamma correction curve; and
an output portion, configured to output the pixel driving voltage based on the gradation voltages that have undergone the gamma correction.

5. The source driver according to claim 4, wherein
a plurality of gamma curve generation portions and a plurality of decoder portions are provided for each channel composed of the plurality of source lines, and
the source driver comprises a decoder selection circuit configured to select one of the decoder portions for each channel from among the plurality of decoder portions.

6. A source driver, which is a source driver configured to be connected to a display panel having a plurality of source lines and a plurality of pixel portions connected to the plurality of source lines, receive a video data signal including a series of plurality of pixel data fragments, and output a pixel driving voltage to be applied to the plurality of pixel portions based on the video data signal, the source driver comprising:
a gamma curve generation portion, configured to receive input of gamma setting data, which is setting information for gamma correction corresponding to at least one partial area of a display screen of the display panel, and generate a local gamma correction curve, which is a gamma correction curve corresponding to the at least one partial area, based on the gamma setting data.

7. The source driver according to claim 6, further comprising a decoder portion, configured to perform gamma correction of gradation voltages corresponding to the plurality of pixel data fragments for each of the at least one partial area based on the local gamma correction curve.

8. The source driver according to claim 7, further comprising an output portion, configured to output the pixel driving voltage based on the gradation voltages that have undergone the gamma correction.

9. The source driver according to claim 6, wherein
a plurality of gamma curve generation portions and a plurality of decoder portions are provided for each channel composed of the plurality of source lines.

10. The source driver according to claim 9, further comprising a decoder selection circuit configured to select one of the decoder portions for each channel from among the plurality of decoder portions.
